(19) United States
(12) Patent Application Publication
(10) Pub. No.: US 2008/0021955 A1
(43) Pub. Date: Jan. 24, 2008

(54) Message oriented middleware server pipeline architecture

(75) Inventor: Jared D. Stallings, Denver, CO (US)

Correspondence Address: KUTAK ROCK, LLP, 1801 CALIFORNIA STREET, SUITE 3100, DENVER, CO, 80202-2626, US

(73) Assignee: Raytheon Company

(21) Appl. No.: 11/492,170

(22) Filed: Jul. 24, 2006

(51) Int. Cl. G06F 15/16

(52) U.S. Cl. 709/203; 709/202

(57) ABSTRACT

A messaging system includes at least one MOM server. At least one pipeline is located in the server, and at least one pipeline stage is located in the pipeline. The messaging system further includes at least one pipeline transporter, at least one queue in communication with the pipeline, and at least one thread.

### FIELD

This invention relates generally to message oriented middleware servers, and, in particular, to the use of a pipeline architecture in a message oriented middleware server.

### BACKGROUND

Computer networks often have a client-server configuration, in which one or more clients are connected to a server via a communication medium, such as an Ethernet link. The server provides one or more services to the clients. For example, the server may provide the clients messaging services or file storage services.

Clients in a client-server configuration often find it necessary to send messages among each other via the server. For example, two users, each using a different computer terminal, may wish to exchange messages. Each computer terminal is a client connected to a server. Consequently, each client will exchange messages with the other client via the server. As another example, two computerized instruments in a spacecraft may be connected to a server. The two computerized instruments, which are considered clients, may exchange messages with each other via the server.

A messaging system may be implemented to handle the transfer of messages among clients of a computer network having a client-server configuration. The messaging system typically has a cluster of one or more servers. Each client is connected to the cluster by a connection to one of the servers in the cluster. The servers in the cluster cooperate to transfer messages among clients connected to the cluster. It is not necessary for clients to be connected to the same server in order for them to transfer messages among themselves. For example, consider a cluster having two servers and two clients. One client is connected to one server, and the other client is connected to the other server. Because both clients are connected to the same cluster, they can exchange messages with each other even though they are connected to different servers.

Clusters may use a variety of platforms to process messages. One possible platform is a request/response platform. In a request/response platform, two clients that wish to exchange a message must coordinate the exchange with each other in real time.

Another platform for processing messages is commonly referred to as Message Oriented Middleware (“MOM”). A server having a MOM platform (“MOM server”) transfers messages from one client to another in an asynchronous manner. Thus, clients connected to a cluster operating on a MOM platform do not need to coordinate among themselves the transfer of a message.

Advantages of asynchronous message transfer include the ability of the cluster to store, route, or transform a message while it being delivered. Consequently, a message sent in an asynchronous manner may be sent to a plurality of clients, and the message may be modified by the cluster as it is being delivered. Additionally, if the cluster has persistent storage to back up the message, a sending client and a receiving client do not need to be simultaneously connected to the cluster in order to transfer a message among themselves. If the receiving client is not connected to the cluster at the time the message is sent, the cluster may hold the message in persistent storage until a time when the receiving client connects to the cluster.

It is frequently desirable to customize a MOM server. By way of example, if a messaging system application operated by the MOM server has special requirements, the MOM server may require customization to enable it to handle these requirements. Special requirements may include message throughput features, special message filtering capabilities, and/or guaranteed message delivery requirements. Another possible reason to customize a MOM server is to optimize the MOM server's performance in a given application.

Although it is frequently desirable to customize a MOM server, sections of code generally must be modified, added, and/or deleted to customize a MOM server. Such code changes are often difficult, complex, and/or time consuming. Consequently, an MOM server architecture that will facilitate customization of the MOM server is needed.

### SUMMARY

The pipeline architecture and applications thereof herein disclosed advance the art and overcome at least one of the problems articulated above by providing a MOM server architecture that facilitates customization of the MOM server.

In particular, and by way of example only, according to one embodiment, a messaging system includes at least one MOM server. At least one pipeline is located in the server, and at least one pipeline stage is located in the pipeline. The messaging system further includes at least one pipeline transporter, at least one queue in communication with the pipeline, and at least one thread.

According to another embodiment, a method of processing an object received by a message oriented middleware server includes placing the object in a pipeline transporter and placing the pipeline transporter in a queue. The pipeline transporter is removed from the queue when a pipeline is ready to accept the pipeline transporter, and the pipeline transporter is placed in a predetermined stage of the pipeline. The pipeline transporter is advanced sequentially through each stage of the pipeline, and the object is processed by a stage housing the pipeline transporter. The pipeline transporter is removed from the pipeline after each pipeline stage has processed the object, and the object is removed from the pipeline transporter.

In yet another embodiment, a method of changing an operating state of a plurality of server components comprises providing a pipeline stage for each server component. Each pipeline stage is associated with a respective server component. An ordered collection of pipeline stages is created, wherein the ordered collection of pipeline stages consists of each pipeline stage linearly disposed with respect to other pipeline stages in a predetermined order. A pipeline including the ordered collection of pipeline stages is created. A state transition command is placed in a pipeline transporter, and the pipeline transporter is placed in a queue until the pipeline is ready to accept the pipeline transporter. The pipeline transporter is placed in a predetermined stage of the pipeline, and the pipeline transporter is sequentially advanced through each stage of the pipeline. The state transition command is processed by the stage housing the pipeline transporter.

### BRIEF DESCRIPTION OF THE DRAWINGS

FIG. 1 is a schematic of a messaging system, according to an embodiment.

FIG. 2 is block diagram of a MOM server having a pipeline architecture, according to an embodiment.

FIG. 3 is a block diagram of a method of processing a message or a state transition command using a pipeline, according to an embodiment.

FIG. 4 is block diagram of a non-persistent messaging pipeline, according to an embodiment.

FIG. 5 is block diagram of a persistent messaging pipeline, according to an embodiment.

FIG. 6 is block diagram of a client command processing pipeline, according to an embodiment.

FIG. 7 is block diagram of a cluster command processing pipeline, according to an embodiment.

FIG. 8 is block diagram of a server command processing pipeline, according to an embodiment.

FIG. 9 is block diagram of a state transition processing pipeline, according to an embodiment.

### DETAILED DESCRIPTION

Before proceeding with the detailed description, it is to be appreciated that the present teaching is by way of example only, not by limitation. The concepts herein are not limited to use or application with a specific type of MOM server pipeline architecture. Thus, although the instrumentalities described herein are for the convenience of explanation, shown and described with respect to exemplary embodiments, it will be appreciated that the principles herein may be applied equally in other types of MOM server pipeline architectures.

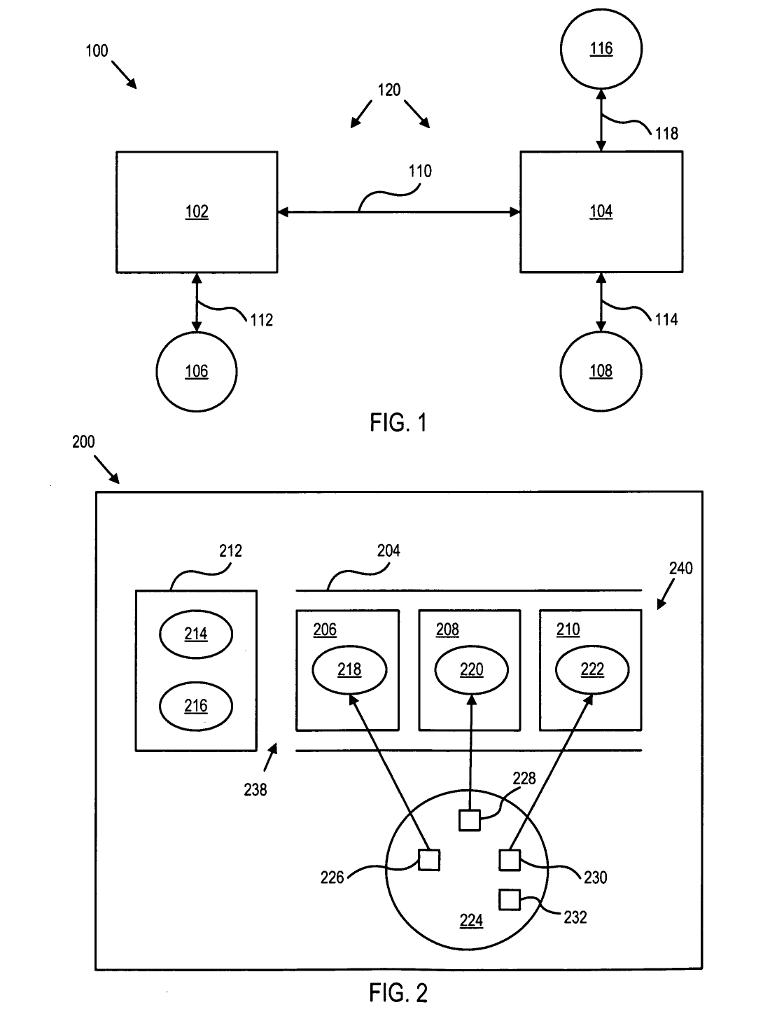

FIG. 1 schematically illustrates messaging system 100. Messaging system 100 includes cluster 120, which, for purposes of illustration is shown having MOM servers 102 and 104 connected via communication link 110. It is to be understood, however, that depending on the size of cluster 120, any number of servers may be employed. Client 106 is connected to server 102 via communication link 112. Client 108 is connected to server 104 via communication link 114. Client 116 is connected to server 104 via communication link 118.

Cluster 120 handles the transfer of messages from one client to another. Consequently, clients 106, 108, and 116 do not directly transfer messages to each other.

For purposes of illustration of the system methodology, assume client 116 desires to send a message to client 108. Client 116 creates and maintains a connection with server 104 via communication link 118. Client 108 in turn creates and maintains a connection with server 104 via communication link 114. The message is transferred from client 116 to client 108 via communication link 118, server 104, and communication link 114.

Servers 102 and 104 within cluster 120 cooperate in the transfer of a message if necessary. For example, if client 116 desires to send a message to client 106, server 104 receives the message from client 116 via communication link 118. Server 104 then transfers the message to server 102 via communication link 110. In turn, server 102 transfers the message to client 106 via communication link 112.

Cluster 120 also handles the processing of state transition commands (“Commands”). A Command instructs a server to change an operating state of a server process. A server may receive a Command from a client or from another server. Alternately, a server may internally generate a Command. If the server receives a Command from a client, the server returns the result of the Command to the client after processing the Command. By way of example, a client may send a Command to a server requesting registration by the server, deregistration by the server, registration for subscription to a specific message type, or deregistration for subscription to a specific message type. Servers 102 and 104 may each maintain a list of internal state information to keep track of executed Commands. For example, servers 102 and 104 may use their lists of internal state information to keep track of all registered clients and to route specific message types to clients that have subscribed to such message types.

By way of example and not of limitation, clients 106, 108, and 116 may be Java applications and/or C++ applications. Cluster 120 may capable of processing Java commands, C++ commands, and/or other command architectures.

FIG. 2 is block diagram of MOM server 200 having a pipeline architecture. Server 200 may operate as a stand alone server in a messaging system. Alternately, server 200 may be a member of a cluster of servers, such as cluster 120 of FIG. 1. The use of the pipeline architecture in a MOM server may offer advantages over prior art MOM server architectures, including ease and flexibility in configuring, customizing, and optimizing the MOM server.

Server 200 includes one or more pipelines to process messages and/or Commands. A message and/or a Command may also be referred to as an object. For illustrative purposes only and not by way of limitation, server 200 is shown in FIG. 2 as having pipeline 204 with three pipeline stages, pipeline stages 206, 208, and 210. However, server 200 may have any quantity of pipelines, and each pipeline may have any quantity of pipeline stages.

A pipeline is an ordered collection of pipeline stages arranged in a linear manner. Each pipeline stage has the ability to processes a message and/or a Command located in the pipeline stage. Thus, each pipeline stage provides one or more types of message or Command processing functions.

A message or Command is transported sequentially through pipeline 204 by a pipeline transporter. A pipeline transporter houses a message or Command and is capable of moving sequentially through a pipeline. For illustrative purposes, FIG. 2 includes pipeline transporters 214, 216, 218, 220, and 222, each of which house a message (not shown) or a Command (not shown). Each pipeline stage processes the message or Command housed in a pipeline transporter while the pipeline transporter is located within the pipeline stage. Thus, a message or Command to be processed by a pipeline must travel through each pipeline stage and be processed by each pipeline stage. A pipeline transporter enters pipeline 204 at input 238 and exits pipeline 204 at output 240. FIG. 2 illustrates pipeline stage 206 processing the message or Command housed in pipeline transporter 218, pipeline stage 208 processing the message or Command housed in pipeline transporter 220, and pipeline stage 210 processing the message or Command housed in pipeline transporter 222.

Queue 212 is located at input 238 of pipeline 204. Queue 212 holds pipeline transporters 214 and 216 waiting to enter pipeline 204. A pipeline transporter may have to wait to enter a pipeline if the pipeline is full, busy, or otherwise unable to accept the pipeline transporter. Although FIG. 2 shows queue 212 holding two pipeline transporters, the quantity of pipeline transporter held by queue 212 will vary with server 200 operating conditions and server 200 design and configuration. For example, the quantity of pipeline transporters held in queue 212 may depend on factors including the quantity of messages or Commands waiting to be processed by pipeline 204, the number of stages in pipeline 204, as well as the processing speed of server 200.

In an embodiment, threads in message handling thread pool 224 control the movement of pipeline transporters through pipeline 204. Each pipeline in server 200 may have a dedicated message handling thread pool. A thread represents the ability of a computer program to do work, and a thread is generally independent of other threads. Consequently, threads 226, 228, 230, and 232 may operate independently of each other.

A thread can control the movement of only a single pipeline transporter at a given time. Consequently, a thread is required for each pipeline transporter that is to be processed at a given time. For illustrative purposes, message handling thread pool 224 includes four threads, threads 226, 228, 230, and 232. However, message handling thread pool 224 may include another quantity of threads. FIG. 2 shows thread 226 controlling the movement of pipeline transporter 218, thread 228 controlling the movement of pipeline transporter 220, and thread 230 controlling the movement of pipeline transporter 222.

In an embodiment, message handling threads monitor or poll queue 212 for a pipeline transporter waiting to enter pipeline 204. For example, thread 232 is polling queue 212 for a pipeline transporter waiting to enter pipeline 204. When a message handling thread identifies a pipeline transporter waiting to enter pipeline 204 and pipeline 204 is ready to accept the pipeline transporter, the message handling thread removes the pipeline transporter from queue 212 and places it in the first pipeline stage 206, pipeline stage 206.

In an embodiment, a message handling thread controls processing of a message or Command by a pipeline stage as follows. The message handling thread calls the pipeline stage's methods, passing into the methods the specific pipeline transporter instance as a parameter to the method. The pipeline stage's methods are the computer program routines the pipeline stage uses to act on the message or Command and perform the appropriate actions based on the contents of the transporter. For example, a message handling pipeline stage's methods would include message processing routines or Command handling routines.

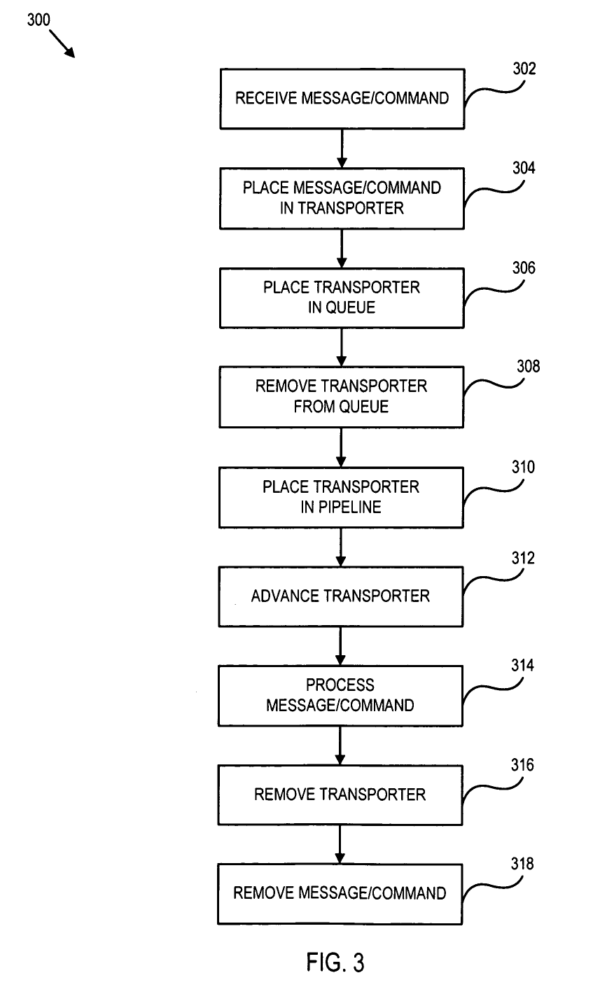

FIG. 3. is a block diagram of method 300, an embodiment of a method of processing a message or Command using pipeline 204. Method 300 begins with step 302 wherein server 200 receives a message or a Command. As was stated above, server 200 may receive the message or Command from a client or from another server. The Command may also be internally generated by server 200.

In step 304, the message or Command is placed in a pipeline transporter which is used to transport the message or Command through pipeline 204. For example, the message or Command may be placed in pipeline transporter 214. In step 306, the pipeline transporter is placed in queue 212 to wait to enter pipeline 204.

In step 308, the pipeline transporter is removed from queue 212 when pipeline 204 is ready to accept the pipeline transporter. In step 310, the pipeline transporter is placed in the first pipeline stage, pipeline stage 206. The pipeline transporter is then advanced sequentially through each pipeline stage in step 312. In step 314, which is executed concurrently with steps 310 and 312, the message or Command housed in the pipeline transporter is processed by the pipeline stage that the pipeline transporter is currently located in. Stated simply, in step 314, the message or Command is processed by each pipeline stage as it travels through pipeline 204 via its pipeline transporter.

In step 316, the pipeline transporter is removed from pipeline 204 after the message or Command housed in the pipeline transporter has been processed by each pipeline stage. Finally, the message or Command is removed from the pipeline transporter in step 318.

A basic set of reusable pipeline stages may be provided to enable creation of one or more of message or Command processing pipelines in a MOM server. Each pipeline has the combined functionality of each of its pipeline stages. By way of an example, assume an embodiment of a message processing pipeline is desired. The desired functions of the message processing pipeline are identified. Individual pipeline stages that provide the desired functions are identified and combined in a linear manner to create a pipeline. The resulting pipeline has the combined functionality of each of its pipeline stages. The configuration of one or more pipelines, such as what pipeline stages participate in the pipelines and in what order the pipeline stages are disposed in the pipelines, may be specified in a configuration script that is read by server 200 at runtime. Because message and/or Command processing functionality may be created simply by combining pipeline stages in a pipeline, the use of a pipeline architecture in a MOM server facilitates customization of the MOM server.

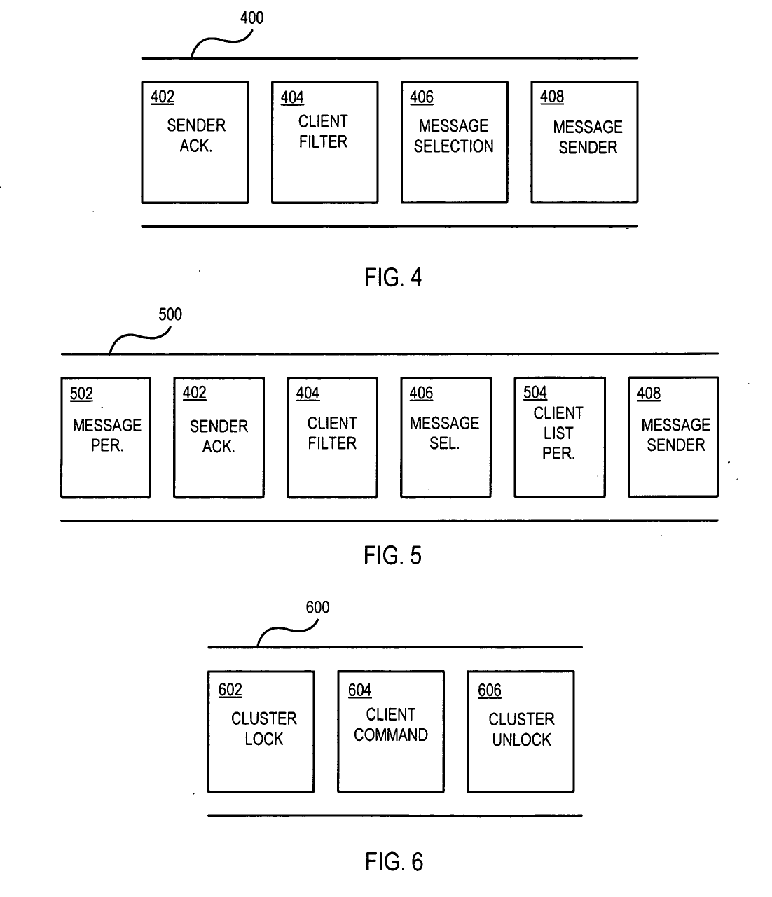

Examples of various embodiments of pipelines are found in FIGS. 4-9 below. Although FIGS. 4-9 are explained with reference to server 200 of FIG. 2, the pipelines of FIGS. 4-9 may be used in any MOM server.

FIGS. 4 and 5 illustrate embodiments of message processing pipelines. It may be appreciated that the embodiments of FIGS. 4 and 5 have several common pipeline stages, thus illustrating how a single pipeline stage may be a building block for a plurality of pipelines.

FIG. 4 is a block diagram of non-persistent messaging pipeline 400. Non-persistent messaging pipeline 400 is an embodiment of a message processing pipeline which may be used in server 200. As its name implies, non-persistent messaging pipeline 400 does not provide persistent storage for messages. Persistent storage may be used to store a message or data related to a message for future use. For example, persistent storage may be used to store a message for later delivery to a client that is currently unable to accept delivery of the message. For purposes of illustration of persistent storage, assume that client 1 sends a message to client 2 via a MOM server. If client 2 is currently unavailable, the server may store the message in persistent storage for later delivery to client 2. If the server does not have access to persistent storage, the server will be forced to abandon the message, and the message will not be delivered to client 2.

Non-persistent messaging pipeline 400 includes sender acknowledgment pipeline stage 402, client filter pipeline stage 404, message selection pipeline stage 406, and message sender pipeline stage 408.

Sender acknowledgment pipeline stage 402 acknowledges to a message sender that server 200 is processing the message. Client filter pipeline stage 404 creates a list of consumers (i.e. other clients) that have registered with server 200 or another server in its cluster as consumers of the message. The list of consumers is a list of potential candidates to receive the message. The list of consumers is saved by the pipeline transporter located within client filter pipeline stage 404. The pipeline transporter saves the list of consumers in its state information, wherein its state information consists of operating states of one or more attributes of the pipeline transporter.

In an embodiment, client filter pipeline stage 404 may include a pipeline having a message selection pipeline stage (not shown) and a message sender pipeline stage (not shown). Thus, client filter pipeline stage 404 may constitute a pipeline within a pipeline.

Message selection pipeline stage 406 filters what messages are sent to a given client. Message selection pipeline stage 406 compares a message's properties against a client's filter settings to determine if the message should be sent to the client.

Message sender pipeline stage 408 hands off a message intended for a client to one or more connection management stages of server 200. It should be noted that a message will be processed by message sender pipeline stage 408 only if the message is forwarded by client filter pipeline stage 404 and not filtered by message selection pipeline stage 406.

FIG. 5 is block diagram of persistent messaging pipeline 500. Persistent messaging pipeline 500 is an embodiment of a message processing pipeline which may be used in server 200 to process persistent messages. A persistent message is one that is guaranteed to be delivered to an appropriate one or more clients, even if the one or more clients are unable to accept delivery of the message when delivery is first attempted.

Persistent messaging pipeline 500 includes message persistence pipeline stage 502, sender acknowledgment pipeline stage 402, client filter pipeline stage 404, message selection pipeline stage 406, client list persistence stage 504, and message sender pipeline stage 408. Sender acknowledgment pipeline stage 402, client filter pipeline stage 404, message selection pipeline stage 406, and message sender pipeline stage 408 are identical to such stages in non-persistent messaging pipeline 400 of FIG. 4.

Message persistence pipeline stage 502 places a message into persistent storage. As was noted above, persistent storage may be used to store a message for later delivery. Client list persistence stage 504 places the list of consumers from client filter pipeline stage 404 into persistent storage. A user may implement message persistence pipeline stage 502 and client list persistence stage 504 in a manner that meets the user's database and persistence requirements.

FIGS. 6-8 illustrate embodiments of Command processing pipelines. Commands received by server 200 may need to be processed as a series of specific steps. The steps that must be executed to process a given Command frequently depend on whether server 200 received the Command from a client or from another server, or if the Command was internally generated by server 200. Because a pipeline consists of an ordered set of one or more pipeline stages, use of the pipeline architecture in a MOM server may provide a simple and efficient way to implement sequential Command processing steps.

FIG. 6 is block diagram of client command processing pipeline 600. Pipeline 600 is an embodiment of a Command processing pipeline which may be used in server 200 to process Commands received from clients. Pipeline 600 includes cluster lock pipeline stage 602, client command processing pipeline stage 604, and cluster unlock pipeline stage 606.

Cluster lock pipeline stage 602 may be used if it is desired to synchronize execution of Commands in a cluster of servers. Cluster lock pipeline stage 602 may used to implement a part of an acceptable synchronization method. Client command processing pipeline stage 604 executes the Command sent by the client. Cluster unlock pipeline stage 606 may be used to implement another part of the synchronization method. If a synchronization method is not used, pipeline 600 would not include cluster lock pipeline stage 602 and cluster unlock pipeline stage 606.

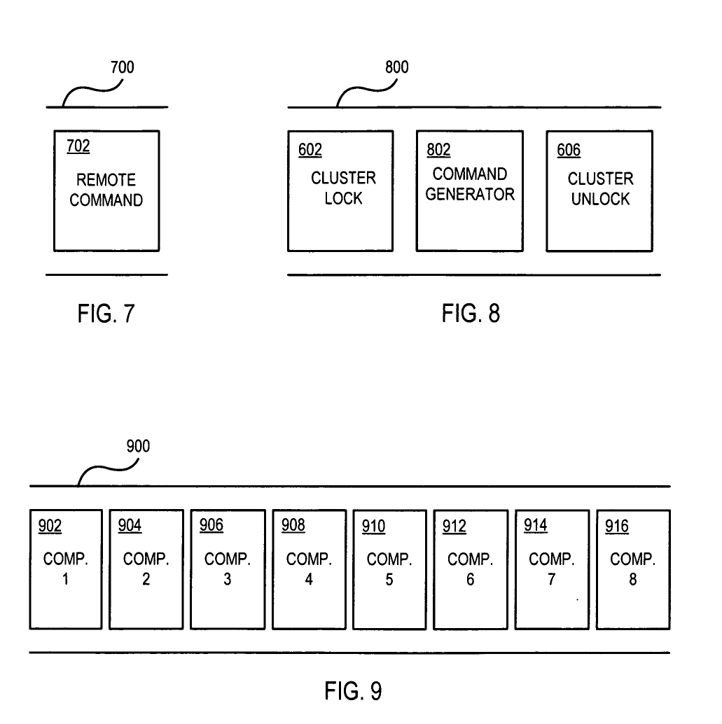

FIG. 7 is block diagram of cluster command processing pipeline 700. Pipeline 700 is an embodiment of a Command processing pipeline which may be used in server 200 to process Commands received from other servers within a cluster. Pipeline 700 includes remote command pipeline stage 702. Remote command pipeline stage 702 executes a specific Command requested by another server within the cluster.

FIG. 8 is block diagram of server command processing pipeline 800. Server command processing pipeline 800 is an embodiment of a Command processing pipeline which may be used in server 200 of FIG. 2 to process Commands generated internally by server 200. Server command processing pipeline 800 includes cluster lock pipeline stage 602, command generator pipeline stage 802, and cluster unlock pipeline stage 606.

Cluster lock pipeline stage 602 and cluster unlock pipeline stage 606 are identical to such stages in client command processing pipeline 600. If a synchronization method is not used, pipeline 800 would not include cluster lock pipeline stage 602 and cluster unlock pipeline stage 606.

Command generator pipeline stage 802 generates Commands that server 200 needs to have executed by other servers in a cluster. Command generator pipeline stage 802 then sends such Commands to the servers in the cluster and handles responses to such Commands received from the other servers in the cluster.

FIG. 9 is a block diagram of state transition processing pipeline 900. Pipeline 900 is an embodiment of a Command processing pipeline which may be used to insure that server components transition to a given state in a predetermined order. A server component is an entity within a server that provides one or more functions. A server component may need to transition to a different operating state by executing a Command. For example, a server component may need to transition to an initialization state, a registration state, a running state, a pause state, a stop state, or a fatal error state by executing an appropriate Command.

The order in which server components execute Commands and thereby transition to a given state are significant, in as much as a plurality of server components may need to transition to a different operating state in a specific order. State transition processing pipeline 900 may be used to insure that server components transition to a given state in a predetermined order. A state transition processing pipeline 900 may be provided for each state that server components may transition to.

For purposes of illustration, a server is assumed to have eight server components in FIG. 9. Consequently, state transition processing pipeline 900 includes eight pipeline stages, and each pipeline stage corresponds to one of the eight server components. Pipeline stage 902 corresponds to server component 1, pipeline stage 904 corresponds to server component 2, pipeline stage 906 corresponds to server component 3, pipeline stage 908 corresponds to server component 4, pipeline stage 910 corresponds to server component 5, pipeline stage 912 corresponds to server component 6, pipeline stage 914 corresponds to server component 7, and pipeline stage 916 corresponds to server component 8.

When a server needs to transition to a new state, a pipeline transporter is populated with an appropriate Command. A message handling thread (not shown) moves the pipeline transporter sequentially through each pipeline stage of state transition processing pipeline 900. Because each pipeline stage 902, 904, 906, 908, 910, 912, 914, and 916 corresponds to a server component, each server component transitions to the new state in the order that it is disposed within state transition processing pipeline 900.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A messaging system, comprising:
at least one message oriented middleware server;
at least one pipeline located in the server;
at least one pipeline stage located in the pipeline;
at least one pipeline transporter;
at least one queue in communication with the pipeline; and
at least one thread.

2. The system of claim 1, wherein the at least one pipeline stage is operable to process a message or a command.

3. The system of claim 1, wherein the at least one pipeline stage is operable to change a state of a message or a command.

4. The system of claim 1, wherein the at least one thread is operable to control movement of a single pipeline transporter through the pipeline.

5. The system of claim 1, wherein the at least one pipeline stage is linearly disposed in a command sequence with respect to other pipeline stages.

6. The system of claim 1 further comprising a configuration script defining the at least one pipeline.

7. The system of claim 1 further comprising a plurality of message oriented middleware servers, each server including at least one pipeline.

8. The system of claim 1, wherein the at least one message oriented middleware server includes:
a sender acknowledgment pipeline stage;
a client filter pipeline stage;
a message selection pipeline stage; and
a message sender pipeline stage.

9. The system of claim 8, wherein the at least one message oriented middleware server includes:
a message persistence pipeline stage; and
a client list persistence pipeline stage.

10. The system of claim 1, wherein the at least one message oriented middleware server includes:
a cluster lock pipeline stage;
a client command processing pipeline stage; and
a cluster unlock pipeline stage.

11. The system of claim 1, wherein the at least one message oriented middleware server includes a remote command pipeline stage.

12. The system of claim 1, wherein the at least one message oriented middleware server includes:
a cluster lock pipeline stage;
a command generator pipeline stage; and
a cluster unlock pipeline stage.

13. The system of claim 1, wherein the at least one pipeline is operable to change an operating state of at least one server component.

14. The system of claim 1 wherein the at least one message oriented middleware server includes a pipeline associated with a server component operating state.

15. The system of claim 14, wherein the pipeline associated with a server component operating state includes a pipeline stage associated with each server component.

16. The system of claim 1, wherein the system interacts with Java clients.

17. The system of claim 1, wherein the system interacts with C++ clients.

18. A method of processing an object received by a message oriented middleware server, comprising the steps of:
placing the object in a pipeline transporter;
placing the pipeline transporter in a queue;
removing the pipeline transporter from the queue when a pipeline is ready to accept the pipeline transporter;
placing the pipeline transporter in a predetermined stage of the pipeline;
advancing the pipeline transporter sequentially through each stage of the pipeline;
processing the object by a stage housing the pipeline transporter;
removing the pipeline transporter from the pipeline after each pipeline stage has processed the object; and
removing the object from the pipeline transporter.

19. The method of claim 18, wherein the object comprises a message or a command.

20. A method of changing an operating state of a plurality of server components, comprising the steps of:
providing a pipeline stage for each server component;
associating each pipeline stage with a respective server component;
creating an ordered collection of pipeline stages having each pipeline stage linearly disposed with respect to other pipeline stages in a predetermined order;
creating a pipeline including the ordered collection of pipeline stages;
placing a state transition command in a pipeline transporter;
placing the pipeline transporter in a queue until the pipeline is ready to accept the pipeline transporter;
placing the pipeline transporter in a predetermined stage of the pipeline;
advancing the pipeline transporter sequentially through each stage of the pipeline; and
processing the state transition command by a stage housing the pipeline transporter.
